(19) United States
(12) Patent Application Publication
(10) Pub. No.: US 2025/0343617 A1
(43) Pub. Date: Nov. 6, 2025

(54) SYSTEMS AND METHODS FOR ADAPTIVE TIME AND FREQUENCY DIVISION MULTIPLEXING IN COHERENT PASSIVE OPTICAL NETWORKS

(71) Applicant: CABLE TELEVISION LABORATORIES, INC., Louisville, CO (US)

(72) Inventors: Haipeng Zhang, Broomfield, CO (US); Karthik Kumar Choutagunta Nagaraj, Broomfield, CO (US); Zhensheng Jia, Superior, CO (US)

(21) Appl. No.: 19/193,544

(22) Filed: Apr. 29, 2025

Related U.S. Application Data
(60) Provisional application No. 63/642,328, filed on May 3, 2024.

(51) Int. Cl. H04J 14/02; H04J 14/08

(52) U.S. Cl. CPC H04J 14/023; H04J 14/0257; H04J 14/08

(57) ABSTRACT

Systems and methods for providing adaptive time and frequency division multiplexing in coherent passive optical networks are provided. The systems include an OLT configured to transmit a downstream optical signal to a plurality of ONUs disposed remotely from the OLT. The downstream optical signal includes at least a first data subcarrier, a second data subcarrier, and a communication subcarrier each disposed in a frequency domain. The first data subcarrier has a first modulation format and a first baud rate within a first channel bandwidth and the second data subcarrier has a second modulation format and a second baud rate within a second channel bandwidth. The communication subcarrier includes at least one of OAM management data and information for control of a media access control (MAC) layer.

### CROSS REFERENCE TO RELATED APPLICATIONS

This application claims the benefit of U.S. Provisional Application No. 63/642,328, filed on May 3, 2024, which application is incorporated herein by reference in its entirety.

### BACKGROUND

The field of the disclosure relates generally to communication networks, and more particularly, coherent optical networks configured for time-and-frequency-division multiplexing (TFDM) transmission.

Conventional passive optical networks (PONs) are known to use point-to-multipoint (P2MP) architectures that are implemented extensively worldwide, and which have become a primary vehicle to meet the growing capacity demands in optical access networks. PON technology and architectures are expected to grow significantly in the near future, due to such factors as (a) increasing demand for high-speed internet, (b) need for more efficient and reliable network infrastructures, and (c) increasing adoption of fiber-to-the-home (FTTH) and fiber-to-the-premises (FTTP) technologies that rely on PONs to deliver high-speed internet access to homes and businesses. Additionally, driven by the desire for minimal latency, decreased jitter, and enhanced quality of experience (QoE) in virtual reality (VR) games and cloud-based applications, there is a desire in the optical communication field to continue to grow and improve fiber access technologies.

Conventional PONs, however, have focused primarily on intensity modulation direct detection (IM-DD) technology, which has been unable to meet the needs for the emerging 100G PON standard, due to such known IM-DD limitations such as insufficient power budgets, bandwidth limitations, and transmission impairments such as chromatic dispersion (CD). Nevertheless, there is a significant desire in the industry to move even further towards next generation (NG) PONs operating up to speeds of 100 Gb/s (100G) and greater. However, conventional IM-DD technologies are lacking in cost-effective solutions to meet such growth needs.

Recent solutions based on coherent PON (CPON) technology though, have offered solutions to meeting these new high-speed demands, due to the heightened sensitivity, advanced modulation, and robust digital signal processing (DSP) exhibited by CPON, in comparison to IM-DD PONS. Various CPON technologies have been developed over time, including time-division-multiplexing (TDM) PONs, wavelength-division-multiplexing (WDM) PONs, and time-and-frequency-division multiplexing (TFDM) PONs. TFDM CPONs, for example, leverage digital subcarrier multiplexing, while also enabling versatile bandwidth sharing across time and frequency domains over a single wavelength.

Some CPON solutions have been known to implement TFDM technology to enable multiple optical signals to share the same fiber link by allocating distinct digital subcarriers to each signal. Within the allocated subcarriers, time slots facilitate data transmission from various users or services. However, previous implementations of TFDM CPON have been limited in their adaptability and could only offer a constant rate across all digital subcarriers. Thus, there is a desire in the industry to improve upon existing CPON TFDM solutions to enable a more flexible TFDM-based CPON.

### SUMMARY

The techniques of this disclosure generally relate to an adaptive TFDM CPON system that allows each digital subcarrier to adapt its transmission characteristics such as, for example, modulation format and/or baud rate, to enhance the efficiency and adaptability of the TFDM CPON system based on end user's needs as they change over time. The adaptive TFDM CPON system described herein also provides for digital subcarrier modulation directly in the digital domain and can be implemented in existing networks without requiring additional or new components.

In at least one aspect, the present disclosure provides a coherent passive optical network (CPON), comprises an optical line terminal (OLT) configured to transmit a downstream optical signal to a plurality of optical network units (ONUs) disposed remotely from the OLT, the downstream optical signal including a first data subcarrier, a second data subcarrier, and a first communication subcarrier each disposed in a frequency domain; an optical communication medium in operable communication with the OLT, and configured to transport the downstream optical signal to a first ONU and a second ONU; the first ONU of the plurality of ONUs in operable communication with the optical communication medium, including a first ONU receiver configured to receive at least the first data subcarrier having a first modulation format and a first baud rate from the downstream optical signal within a first channel bandwidth, and a first ONU transmitter configured to transmit at least a first upstream data subcarrier to the OLT within the first channel bandwidth; and the second ONU of the plurality of ONUs in operable communication with the optical communication medium, including a second ONU receiver configured to receive at least the second data subcarrier having a second modulation format and a second baud rate from the downstream optical signal within a second channel bandwidth, and a second ONU transmitter configured to transmit at least a second upstream data subcarrier to the OLT within the second channel bandwidth; and wherein the communication subcarrier includes at least one of OAM management data and information for control of a media access control (MAC) layer.

In other aspects, the first modulation format is different from the second modulation format and the first baud rate is different from the second baud rate.

In other aspects, the CPON further comprises the third ONU of the plurality of ONUs in operable communication with the optical communication medium, including a third ONU receiver configured to receive at least the third data subcarrier having a third modulation format and a third baud rate from the downstream optical signal within a third channel bandwidth, and a third ONU transmitter configured to transmit a third upstream signal to the OLT within the third channel bandwidth; and the fourth ONU of the plurality of ONUs in operable communication with the optical communication medium, including a fourth ONU receiver configured to receive at least the fourth data subcarrier having a fourth modulation format and a fourth baud rate from the downstream optical signal within a fourth channel bandwidth, and a fourth ONU transmitter configured to transmit a fourth upstream signal to the OLT within the fourth channel bandwidth.

In other aspects, the communication subcarrier is a first communication subcarrier, and wherein the downstream optical signal further includes a second communication subcarrier.

In other aspects, the second communication subcarrier is dedicated for P2P operation.

In other aspects, the first, second, and third ONUs utilize the first communication subcarrier and are each configured for a point-to-multipoint (P2MP) split ratio, and wherein the fourth ONU utilizes the second communication subcarrier and is configured for P2P transport.

In other aspects, the first modulation format, the second modulation format, the third modulation format, and the fourth modulation format are each different, and wherein the first baud rate, the second baud rate, the third baud rate, and the fourth baud rate are each different.

In other aspects, the first baud rate, the second baud rate, the third baud rate, and the fourth baud rate are set as a fraction of an initial internal oversampling rate.

In other aspects, the initial internal oversampling rate is 62.5 GSa/s.

In other aspects, the first ONU is disposed at a first distance from the OLT, and wherein the second ONU is disposed at a second distance from the OLT greater than the first distance.

In other aspects, the first data subcarrier and the second data subcarrier are each high speed data and the communication subcarrier is low speed data.

In at least one aspect, the present disclosure provides a digital signal processor (DSP) for a coherent transmitter, comprises a channel configuration unit configured to divide a media access control (MAC) data signal into a plurality of digital subcarriers, each digital subcarrier assigned to a frequency band; a plurality of payload generators configured to generate a payload and to assign a baud rate to each digital subcarrier of the plurality of digital subcarriers; a plurality of channel encoders configured to receive, encode, and assign a modulation format to data for each digital subcarrier of the plurality of digital subcarriers; a post-processing unit including at least one of a pulse shaper and a digital up-converter for the plurality of digital subcarriers; and a channel combination unit configured to combine the data into a combined output signal capable of conversion to an analog optical signal for output from the coherent transmitter.

In other aspects, the transmitter is an ONU coherent transmitter, and wherein the ONU coherent transmitter further comprises a burst preamble generator logically disposed between the plurality of payload generation and the plurality of channel encoders, the burst preamble generator configured to construct a preamble for the payload of a respective subcarrier, the preamble including one or more of a guard band, a receiver settling pattern, and a synchronization pattern.

In other aspects, the assigned baud rate is different for at least two subcarriers.

In other aspects, the assigned modulation format is different for at least two subcarriers.

In other aspects, the assigned frequency band is different for at least two subcarriers.

In other aspects, the pulse shaper applies a Nyquist pulse shaping to each subcarrier.

In at least one aspect, the present disclosure provides a digital signal processor (DSP) for a coherent receiver, comprises a digital down converter configured to receive digital subcarriers from the coherent receiver and separate the digital subcarriers into respective baseband signals; a plurality of channel filters configured to filter each respective baseband signal and process a baud rate for each baseband signal; a joint DSP processor for processing the digital subcarriers; a plurality of channel decoders configured to individually receive and decode each digital subcarrier that is output from the joint DSP processor.

In other aspects, the coherent receiver comprises an OLT coherent receiver, and wherein the OLT coherent receiver further comprises a burst detection and synchronization unit logically disposed between the plurality of channel filters and the joint DSP processor, the burst detection and synchronization unit configured to detect burst signal according to a preamble thereof, and then implement one or more of burst frame detection, chromatic dispersion (CD) compensation, burst clock recovery, and burst frame synchronization.

In other aspects, the baud rate is different for at least two digital subcarriers.

In other aspects, the assigned modulation format is different for at least two digital subcarriers.

The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a schematic illustration of a time-and-frequency-division multiplexing (TFDM) coherent passive optical network (CPON) system according to at least one embodiment of the present disclosure;

FIG. 2 is a flowchart according to at least one embodiment of the present disclosure;

FIG. 3A is a logical architecture for an exemplary digital signal processor for a coherent transmitter according to at least one embodiment of the present disclosure;

FIG. 3B is a logical architecture for an exemplary digital signal processor for a coherent receiver according to at least one embodiment of the present disclosure;

FIG. 4A is a schematic illustration of an example test architecture for verifying experimental results implementing the adaptive TFDM CPON system according to at least one embodiment of the present disclosure;

FIG. 4B is a schematic illustration of an example coherent transmitter for verifying the experimental results according to at least one embodiment of the present disclosure;

FIG. 4C is a schematic illustration of an example coherent receiver for verifying the experimental results according to at least one embodiment of the present disclosure;

FIG. 4D is a graph illustrating digital subcarrier configurations according to at least one embodiment of the present disclosure;

FIG. 5A is a graphical illustration depicting a plot obtained using the test architecture depicted in FIG. 4A according to at least one embodiment of the present disclosure;

FIG. 5B is a graphical illustration depicting another plot obtained using the test architecture depicted in FIG. 4A according to at least one embodiment of the present disclosure;

FIGS. 6A-6D are graphical illustrations depicting performance plots obtained using the test architecture depicted in FIG. 4A according to at least one embodiment of the present disclosure;

FIG. 7A is a schematic illustration of another example test architecture for verifying experimental results implementing the adaptive TFDM CPON system according to at least one embodiment of the present disclosure;

FIG. 7B is a graph illustrating digital subcarrier configurations according to at least one embodiment of the present disclosure;

FIG. 8A is a graphical illustrating depicting a plot obtained using the test architecture depicted in FIG. 7A; according to at least one embodiment of the present disclosure;

FIG. 8B is a graphical illustration depicting another plot obtained using the test architecture depicted in FIG. 7A according to at least one embodiment of the present disclosure;

FIGS. 9A-B are graphical illustrations depicting performance plots obtained using the test architecture depicted in FIG. 7A according to at least one embodiment of the present disclosure.

### DETAILED DESCRIPTION

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (i.e., X₁ and X₂) as well as a combination of elements selected from two or more classes (i.e., Y₁ and Zₒ).

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, i.e., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (i.e., a processor) to process the data, and the time of a system response to the events and the environment. In the embodiments described herein, these activities and events occur substantially instantaneously.

As used herein, “modem termination system” (MTS) refers to a termination unit including one or more of an Optical Network Terminal (ONT), an optical line termination (OLT), a network termination unit, a satellite termination unit, a cable modem termination system (CMTS), and/or other termination systems which may be individually or collectively referred to as an MTS.

As used herein, “modem” refers to a modem device, including one or more a cable modem (CM), a satellite modem, an optical network unit (ONU), a DSL unit, etc., which may be individually or collectively referred to as modems.

As used herein, the term “coherent transceiver,” unless specified otherwise, refers to a P2P or P2MP coherent optics transceiver having a coherent optics transmitting portion and a coherent optics receiving portion. In some instances, the transceiver may refer to a specific device under test (DUT) for several of the embodiments described herein.

As described herein, a “PON” generally refers to a passive optical network or system having components labeled according to known naming conventions of similar elements that are used in conventional PON systems. For example, an OLT may be implemented at an aggregation point, such as a headend/hub, and multiple ONUs may be disposed and operable at a plurality of end user, customer premises, or subscriber locations. Accordingly, an “uplink transmission” refers to an upstream transmission from an end user to a headend/hub, and a “downlink transmission” refers to a downstream transmission from a headend/hub to the end user, which may be presumed to be generally broadcasting continuously (unless in a power saving mode, or the like).

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, i.e., for communications, data storage, etc. A data center may include numerous redundant or backup components within the infrastructure thereof to provide power, communication, control, and/or security to the multiple components and/or subsystems contained therein. A physical data center may be located within a single housing facility, or may be distributed among a plurality of co-located or interconnected facilities. A ‘virtual data center’ is a non-tangible abstraction of a physical data center in a software-defined environment, such as software-defined networking (SDN) or software-defined storage (SDS), typically operated using at least one physical server utilizing a hypervisor. A data center may include as many as thousands of physical servers connected by a high-speed network.

As used herein, the term “hyperscale” refers to a computing environment or infrastructure including multiple computing nodes, and having the capability to scale appropriately as increased demand is added to the system, i.e., seamlessly provision infrastructure components and/or add computational, networking, and storage resources to a given node or set of nodes. A hyperscale system, or “hyperscaler” may include hundreds of data centers or more, and may include distributed storage systems. A hyperscale system may utilize redundancy-based protection and/or erasure coding, and may be typically configured to increase background load proportional to an increase in cluster size. A hyperscale node may be a physical node or a virtual node, and multiple virtual nodes may be located on the same physical host. Hyperscale management may be hierarchical, and a “distance” between nodes may be physical or perceptual. A hyperscale datacenter may include several performance optimized datacenters (PODs), and each POD may include multiple racks and hundreds and thousands of computer and/or storage devices.

Exemplary CPON architectures, as well as the respective components thereof, are described in greater detail in U.S. Pat. Nos. 9,912,409, 10,200,123, and 10,523,356. Exemplary systems and methods for coherent burst reception are described in greater detail in U.S. Pat. Nos. 11,575,448 and 11,540,032. An exemplary rate-flexible CPON is described in co-pending U.S. patent application Ser. No. 18/905,880, filed Oct. 3, 2024. The disclosures of all of these prior patents and patent applications are incorporated by reference herein in their entireties.

As described above, the techniques of this disclosure generally relate to an adaptive TFDM CPON system that allows each digital subcarrier to adapt its transmission characteristics such as, for example, modulation format and/or baud rate, to enhance the efficiency and adaptability of the TFDM CPON system based on end user's needs as they change over time. The adaptive TFDM CPON system described herein also provides for digital subcarrier modulation directly in the digital domain and can be implemented in existing networks without requiring additional or new components. For example, in IM-DD PONs, additional hardware is usually required for out-of-band (OOB) communication channels. In the adaptive TFDM CPON described herein, the OOB channels can be integrated directly in the digital domain.

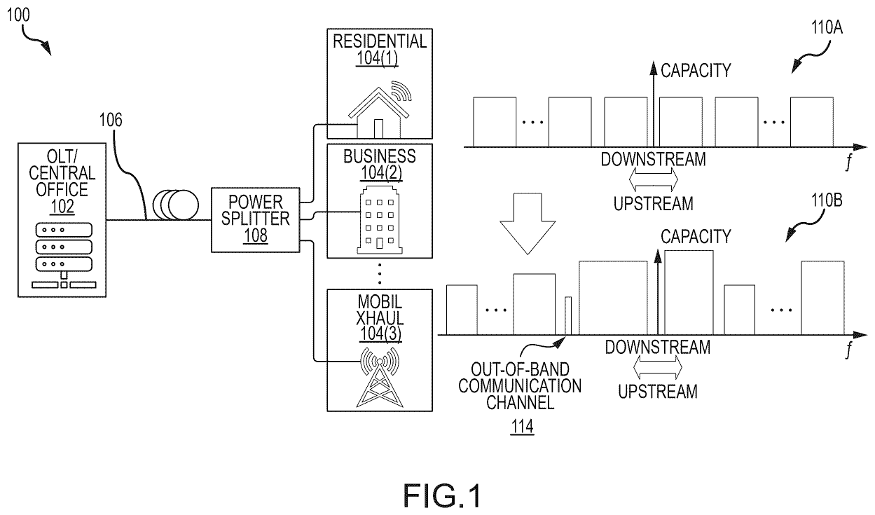

Turning to FIG. 1, a schematic illustration depicting an example adaptive TFDM CPON system (100) is provided. In the illustrated embodiment, the adaptive TFDM CPON system (100) features adaptive capacity and distributed splitting, including a centralized optical line terminal (OLT) (102) in operable communication with a plurality (i.e., 1−N) of end-users (104 (1-3)) (i.e., including respective transceivers thereof, such as ONUs, customer premises equipment (CPEs), modems, etc.). an optical communication medium (106) connects the OLT (102) to respective end-users (104) through at least one power splitter (108) connecting the various portions of the optical communication medium (106) in serial and/or in parallel.

In at least one embodiment, the OLT (102) may be located within a central office, a communications hub, or a headend of an optical link (not separately shown in FIG. 1), and functions to convert standard signals from a service provider (also not shown) to the various frequencies, modulation formats, baud rates, and framing used by the adaptive TFDM CPON system (100). In at least one embodiment, the optical communication medium (106) may include a single mode fiber (SMF), and the power splitters (108) may include a passive splitter and/or a power splitter/combiner.

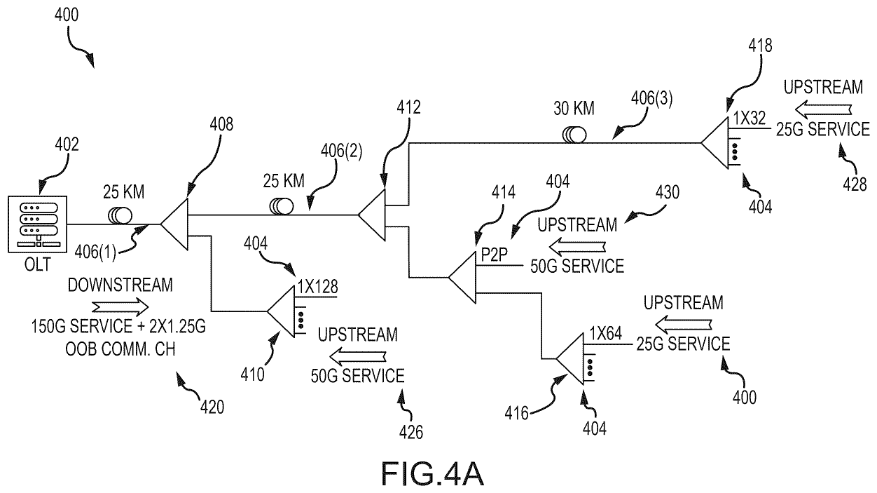

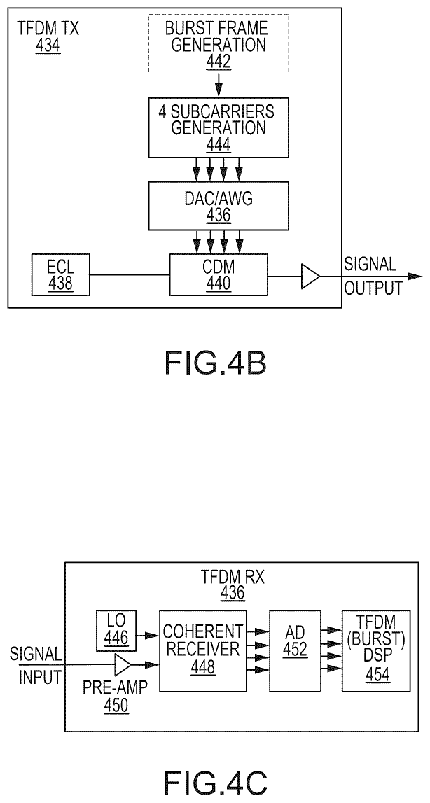

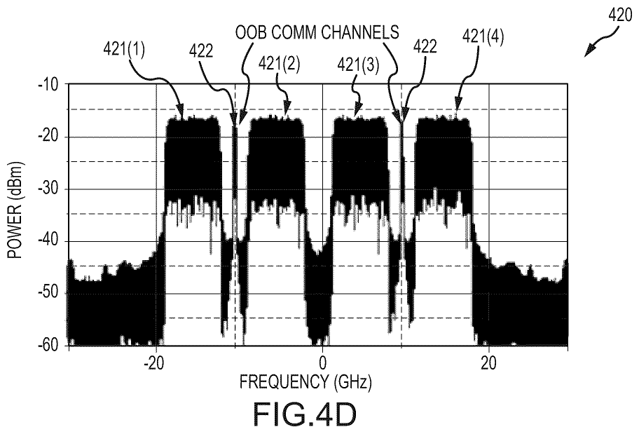

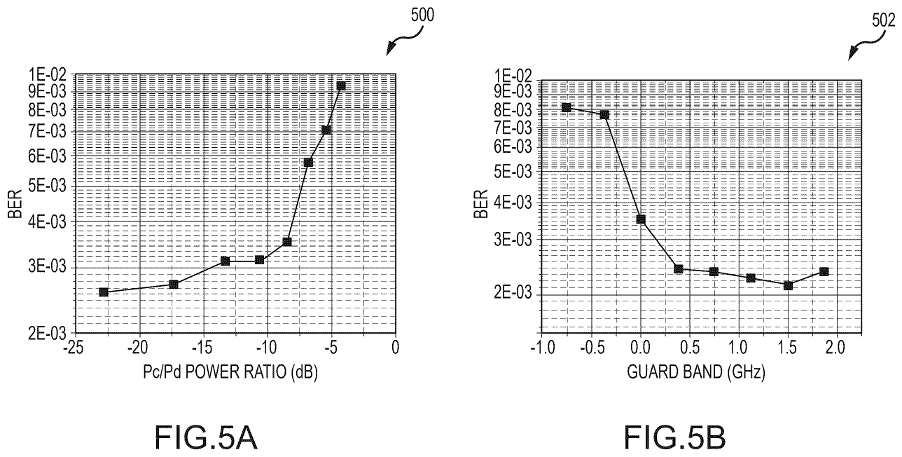

In at least one embodiment, the adaptive TFDM CPON system (100) implements TFDM technology to enable multiple optical signals to share the same fiber link (i.e., optical communication medium (106)) by allocating distinct digital subcarriers to each signal to and from a respective end-user (104). In at least one embodiment, within each allocated subcarrier, time slots facilitate data transmission to/from various users or services. That is, the adaptive TFDM CPON system (100) is shown to illustrate a hybrid point-to-multipoint (P2MP) design concept that includes point-to-point (P2P) portions to incorporate multiple modulation formats into a downstream optical signal from the OLT to respective end-users (104) having varying link budgets to serve to customers in different locations and at different respective distances from the OLT (102), as will be also described in detail in FIGS. 4A and 5.

As shown, each digital subcarrier in a conventional CPON system would have an equal amount of downstream and upstream capacity (110A). In the adaptive TFDM CPON system (100), the downstream and the upstream capacity (110B) of digital subcarriers can be varied. For example, the downstream optical signal can include an out-of-band communication channel (114) for media access controls (MAC) and operations, administration, and maintenance functionalities (OAM) and digital subcarriers with different amounts of downstream and upstream capacities. It will be appreciated that an ONU for a given end user (104) can be configured to receive multiple data subcarriers (i.e., first and second data subcarriers) whether with the same or different modulation formats and baud rate. The ONU can also transmit more than on data subcarrier.

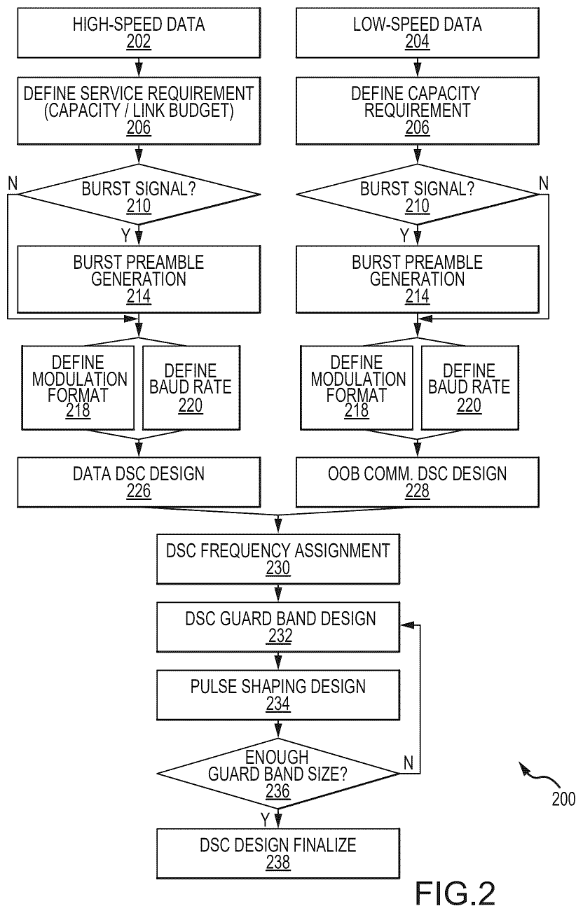

FIG. 2 illustrates a dataflow (200) for a process to design an adaptive TFDM CPON system such as the adaptive TFDM CPON system (100) that is applicable across various deployment scenarios. The dataflow (200) takes into account key factors such as service capacity, link budget, and communication channels to guide development of the digital subcarrier structure for both high-speed and low-speed data transmissions to ensure flexibility in supporting both upstream burst-mode and downstream continuous-mode transmissions.

The dataflow (200) starts by distinguishing between high-speed data services (202) and low-speed data services (204). The low-speed data services (204) may be, for example, communication data. Then, a service requirement (206) for each of the high-speed data (202) and the low-speed data (204) is determined. The service requirement (206) may include, for example, a capacity and/or a link budget. The process then includes determining whether a preamble burst signal (210) is needed to prepare the system for a burst transmission or a continuous transmission based on the service requirement (206). If the preamble burst signal (210) is needed for the high-speed data (202) and/or the low-speed data (204), then a burst preamble is generated (214).

Whether a burst preamble (214) is generated or not, a modulation format (218) and a baud rate (220) are defined for each of the high-speed data (202) and the low-speed data (204) based on the service requirement (206). A data digital subcarrier is then designed (226) for the high-speed data (202) and an out of band (OOB) communication digital subcarrier (228) is designed for the low-speed data (204). The OOB communication digital subcarrier (228) is used for control and monitoring of the adaptive TFDM CPON system (100), which ensures that transmissions for the low-speed data (204) have a dedicated path that does not interfere with the high-speed data (202) transmissions.

The adaptive TFDM CPON system (100) is then configured based on the service requirement(s) (206). The configuration includes assigning each of the data digital subcarrier (226) and the OOB communication digital subcarrier (228) to a frequency (230). Assigning the data digital subcarrier (226) and the OOB communication digital subcarrier (228) includes allocating individual digital subcarrier channels to optimal frequency slots to make efficient use of the spectrum and avoid overlap between the channels. The configuration also includes designing a digital subcarrier guard-band (232) to prevent interference between adjacent digital subcarriers. The configuration further includes configuring pulse shaping (234) to ensure optimal bandwidth efficiency for each digital subcarrier and to minimize inter-symbol interference (ISI), which is essential for maintaining a high-system performance. In some embodiments, the pulse shaping (234) may occur prior to the design of the digital subcarrier guard-band (232).

A size of the guard-band is then determined to be adequate (236) by, for example, comparing the size of the guard-band to a predetermined threshold. If the size of the guard-band is adequate, then the process proceeds to the next step. If the size of the guard-band is not adequate, then the process redesigns the guard-band until the size of the guard-band is adequate. Lastly, the digital subcarrier design is finalized (238).

The process described above results in an adaptive TFDM CPON system (100) with a high degree of flexibility to handle various service types and traffic profiles. Such process also enables the adaptive TFDM CPON system (100) to be adaptable to different network requirements and ensures high-spectral efficiency and system performance in diverse operational environments. An architecture for supporting the adaptive TFDM CPON system (100) will now be described.

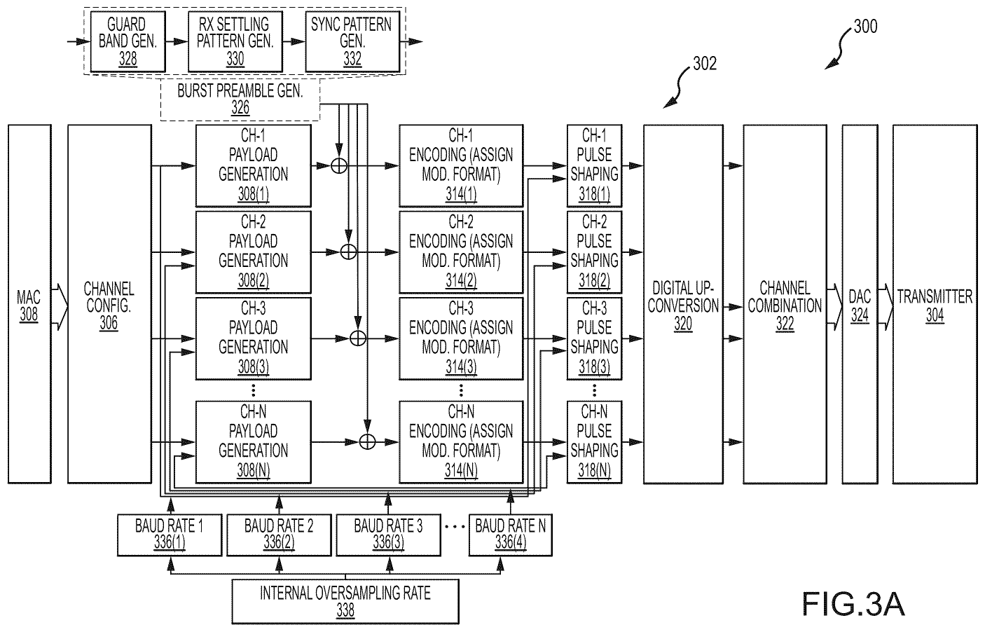

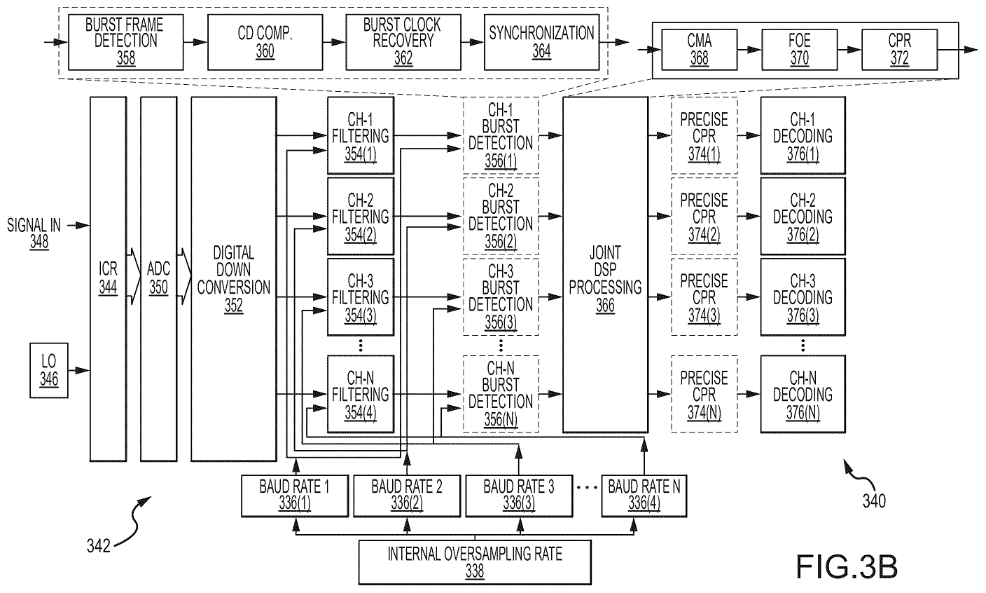

FIG. 3A is a schematic illustration depicting a logical architecture for a transmitter digital signal processor (DSP) (302) for a coherent transmitter (304). The coherent transmitter (304) can be an ONU transmitter or an OLT transmitter. As shown, the transmitter DSP (302) is configured to support various modulation formats, baud rates, and/or digital subcarrier capacities.

In at least one embodiment, the transmitter DSP (302) is configured to receive, at a channel configuration unit (306), data from a MAC layer (308). The channel configuration unit (306) is configured to divide the data received from the MAC layer (308) into respective digital subcarriers in the frequency domain. For high-speed data, the digital subcarriers may be data digital subcarriers and for low-speed data, the digital subcarriers may be OOB communication digital subcarrier. The digital subcarriers are assigned to respective channels and each channel has a payload generated by a respective channel payload generator (308(1−N)) (i.e., at least three channel payload generators (308(1−N)). Each respective channel is then encoded by a respective data channel encoder (314) (i.e., at least three channel encoders (314(1−N)), in this example).

In at least one example of the transmitter DSP (302), a respective pulse shaping unit (318) (i.e., at least three pulse shaping units (318)(1−N)) applies pulse shaping to each of the encoded digital subcarriers. The pulse shaping may be, for example, Nyquist pulse shaping. Each of the pulse-shaped subcarriers may then be up-converted to specific respective inter-frequencies by a digital up-conversion (320). A channel combination unit (322) is then configured to combine the several digital data frames from the data subcarriers and communication subcarriers into an aggregated signal, which then may be converted by a digital-to-analog converter (DAC) (324) into an analog signal for transmission by the coherent transmitter (304). More specifically, the digital subcarriers are multiplexed into a composite signal that drives the modulator, ensuring efficient transmission over the adaptive TFDM CPON system (100).

For upstream optical signals, the transmitter DSP (302) may be additionally configured for implementation with respect to one or more ONU burst transmitters of respective end-users (i.e., end-users (104) of FIG. 1). In this case, the transmitter DSP (302) for an ONU may further include a burst preamble generator (326) disposed between the channel payload generators (308(1−N)) and the data channel encoders (314(1−N)) to generate burst frames for the respective channels. Accordingly, the burst preamble generator (326) may include one or more of a guard band generator (328), a receiver settling pattern generator (330), and a synchronization pattern generator (332), such that payload data of the respective channels may be configured with respective burst frame preambles that include information regarding guard bands, receiver settling patterns, and synchronization patterns. In the case of a continuous signal (i.e., from OLT 102, FIG. 1), burst frame generation may be optional, or unnecessary.

In at least one embodiment, the transmitter DSP (302) is further enabled to assign different modulation formats to each digital subcarrier at the channel encoder (314). Additionally, the transmitter DSP (302) is also enabled to assign different baud rates (i.e., baud rate 1 (336(1)), baud rate 2 (336(2)), baud rate 3 (336(3)), baud rate N (336(4))) to each digital subcarrier. The baud rate variability is achieved through an initial internal oversampling (338), which allows different baud rates to be configured as factors of the oversampling rate. Such baud rates are applied to the respective payload generation (308) and respective pulse shaping (318) of each digital subcarrier, whether for high-speed data services (i.e., data services) or low-speed data services (i.e., OOB communication channels). In some embodiments, lower baud rates are assigned to the low-speed data services or OOB communication channels.

FIG. 3B is a schematic illustration depicting a logical architecture (340) for a receiver digital signal processor (DSP) (342) for a coherent receiver (344) according to at least one embodiment of the present disclosure. The coherent receiver (344) can be an ONU receiver or an OLT receiver. As shown, the logical architecture (340) is similar, in several aspects, to the logical architecture (300) of FIG. 3A, described above, and therefore includes several elements that serve as functional counterparts to respective elements of the logical architecture (300). Accordingly, according to the logical architecture (340), the receiver DPS (342) is also advantageously configured to support various modulation formats and/or digital subcarrier capacities.

In at least one embodiment of the logical architecture (340), the coherent receiver (344) (i.e., an integrated coherent receiver (ICR)) is in operable communication with a local oscillator (LO) (346), and is configured to receive both an LO signal therefrom, and also an input analog optical signal (348) (i.e., downstream optical signal from OLT 102 and upstream optical signals from respective end-user ONUs of FIG. 1) from an optical communication medium (e.g. optical communication medium 106 of FIG. 1). The received analog signals are then converted into digital signals by an analog-to-digital converter (ADC) (350).

In at least one embodiment of the receiver DPS (342), a digital down-converter (352) extracts and separates digital subcarriers of the digital signals, and digitally down-converts each such extracted/separated digital subcarrier into respective baseband signals. Each baseband signal is then filtered by a respective channel filter (354) (i.e., at least three channel filters (354)(1−N)). Such filtering is used to accommodate and process the different baud rates (i.e., baud rate 1 (336(1)), baud rate 2 (336(2)), baud rate 3 (336(3)), baud rate N (336(4)) for each channel.

For burst-mode reception at the OLT (102) of FIG. 1, the receiver DPS (342) includes burst signal detection for each channel by a respective channel burst detector (356) (i.e., at least three burst detectors (1−N)). The burst detection includes power-based burst frame detection (358), followed by chromatic dispersion (CD) compensation (360) and burse clock recovery (362). Burst frame synchronization (364) is achieved through a double-correlation-based algorithm. The information about the baud rate (336) is used in the CD compensation (360) and burst clock recovery (362) during burst reception.

Once the burst signals are detected, payload processing for each channel is processed by a conventional first-stage coherent joint DSP processor (366). The joint DSP processor (366) uses techniques such as, for example, a constant modulus algorithm (CMA) (368), frequency offset estimation (FOE) (370), and/or preliminary carrier phase recovery (CPR) (372) to process multiple modulation formats for each channel. For higher-order modulation formats such as, for example, DP-16QAM and DP-64QAM, additional fine-tuning using respective precise CPRs (374) (i.e., at least three precise CPRs (374)(1−N)) is performed for each channel to enhance signal performance. Each channel is then decoded by a respective channel decoder (376) (i.e., at least three channel decoders (376)(1−N)). In embodiments where the receiver DPS (344) is for ONU receivers, which handle only continuous mode signals, the logical architecture (340) optionally includes or does not include the burst detection stages, simplifying the overall DSP process.

One aspect of an adaptive TFDM CPON system such as the adaptive TFDM CPON system (100) of FIG. 1 is the transmission and detection of upstream burst signals in digital subcarriers. The burst preamble in the TFDM digital subcarriers are structured similarly to previous designs demonstrated in TDM CPON systems in that the preamble is divided into three sections. The first section is dedicated to receiver settling, where automatic gain control is performed by a burst-mode transimpedance amplifier (BM-TIA). When the BM-TIA reaches a steady state, the OLT receiver begins coherent signal processing in burst mode to detect the upstream signals. The second section is used for synchronization, which includes tasks such as, for example, frame synchronization, state of polarization (SOP) estimation, and frequency-offset estimation (FOE). The third section is designed for channel estimation based on constant modulus algorithm (CMA).

Further, for an adaptive TFDM CPON system with adaptable modulation formats, the modulation format used in the payload section can differ from that used in the preamble section. To ensure reliable burst detection and synchronization under fiber transmission impairments, QPSK signals are employed in the preamble section even when higher-order modulation formats such as DP-16QAM or DP-64QAM are used in the payload. In some embodiments, an auto-correlation based algorithm can be used for burst synchronization in TDM systems. To enhance stability and robustness in burst detection under the presence of significant carrier frequency offset (CFO) and CD caused by fiber transmission a double-correlation based synchronization algorithm for the TFDM DSC can be used. Based on a symbol rate of 6.25 GBd per DSC, for the receiver settling, a symbol length of 512 symbols, equivalent to 81.92 ns, can be used. For frame synchronization, stable and robust performance can be achieved when the synchronization symbol length exceeds 32 symbols, corresponding to 5.12 ns. In other embodiments, a synchronization preamble length of 256 symbols (40.96 ns) or longer can be used to ensure robust performance for TFDM coherent burst synchronization.

### Experimental Demonstrations

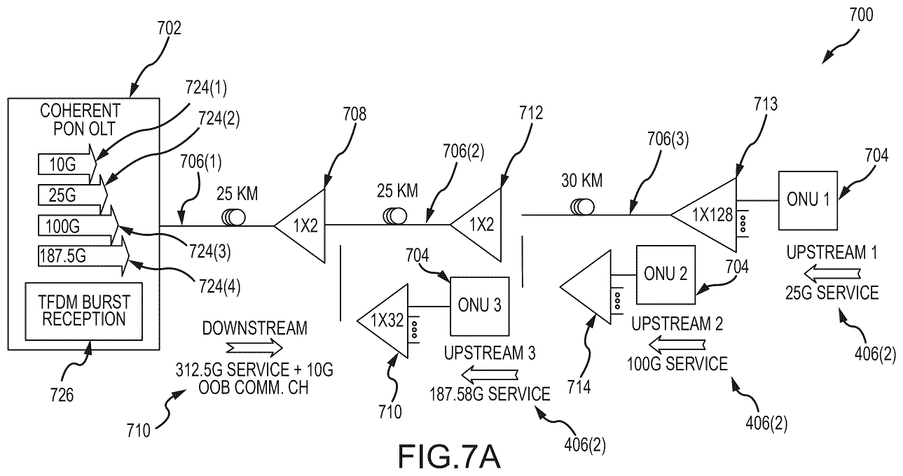

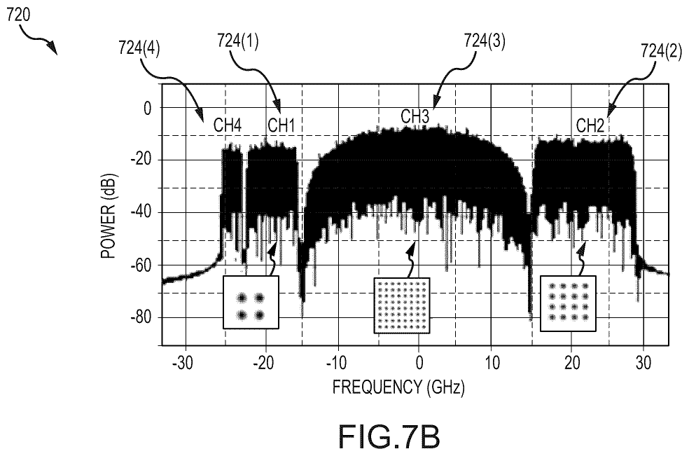

To demonstrate utility of the above embodiments, a first experimental setup and results described in FIGS. 4A-6D and a second experimental setup and results described in FIGS. 7A-9B were configured to demonstrate real-world implementations of the adaptive TFDM CPON system (100) of FIG. 1. The experimental results verify the capability of the present adaptive TFDM CPON system to effectively accommodate distributed splitting configurations across varying distances and split ratios, for example, ranging from 25 km with 128 splits, to 80 km with 32 splits or 128 splits, as well as a 50 km P2P link.

Turning to FIG. 4A, a schematic illustration of an example test architecture (400) for verifying experimental results implementing the adaptive TFDM CPON embodiments are provided. More particularly, the test architecture (400) implemented a real-world operation of an adaptive TFDM CPON, and included an OLT (402) operably coupled to various ONUs of respective end-users (404) through a number of dedicated optical fiber segments (406). For this experiment, a first fiber segment (406(1)) connected the OLT (402) to a first splitter (408) over a 25 km length. From the first splitter (408), a second splitter (410) was configured to implement a 1×128 split ratio for a plurality of high-capacity, short-reach end-users (404) in a P2MP topology (i.e., 128 splits, 25 km from OLT (402)).

A second fiber segment (406(2)), also of 25 km, connected the first splitter (408) to a third splitter (412) to service high-capacity, medium-reach end-users (404) according to both P2P and P2MP topologies. That is, from the third splitter (412), a fourth splitter (414) was configured to split the 50 km signal (i.e., from OLT (402)) for delivery to one high-capacity, medium-reach end-user (404) in a P2P topology, and to a plurality of high-capacity, medium-reach end-users (404) through a fifth splitter (416) implementing a 1×64 split ratio for a P2MP topology at 50 km from OLT 402.

A third fiber segment (406(3)) of 50 km connected the third splitter (412) to a sixth splitter (418) to service lower-capacity, long-reach end-users (404) according to a P2MP topology. That is, the sixth splitter (418) was configured to implement a 1×32 split ratio for a plurality of low-capacity, long-reach end-users (404) in a P2MP topology (i.e., 32 splits at 80 km from OLT 402).

FIG. 4B illustrates a coherent transmitter (TFDM TX) (434) and FIG. 4C illustrates a coherent receiver (TFDM RX) (436) employed in the example test architecture (400). The TFDM TX (434) used a 92-GSa/s four-channel arbitrary waveform generator (AWG) (436) as a signal source and an external cavity laser (ECL) (438) operating with an output power of approximately 15 dBm as the optical carrier. The optical carrier was modulated in both amplitude and phase using a coherent driver modulator (CDM) (440) to support dual-polarization transmission. The TFDM TX (434) also optionally included a burst frame generator (442) and a plurality of subcarrier generators (444).

The TFDM RX (436) combined the incoming optical signal with a local oscillator (LO) laser (446) and the optical signal was detected via balanced photodetectors integrated within a coherent receiver (ICR) (448). Prior to detection, an erbium-doped fiber amplifier (EDFA) was used as a pre-amplifier (450) to boost the optical signal. The In-phase (I) and Quadrature (Q) components of the detected signal were captured by an optical modulation analyzer with an 80-GS/s sampling rate for further analysis. The TFDM RX (436) also included an analog-to-digital convertor (ADC) (452) to convert the signal to a digital signal and a TFDM DSP (454) to process the signal using conventional coherent DSP algorithms.

From this configuration for the test architecture (400), experimental validations were conducted to assess the performance of the present TFDM hybrid CPON embodiments over a variety of adaptable data rates and link budgets. More particularly, from OLT (402) a downstream signal (420) was propagated, as shown in FIG. 4D, which included four sequential data subcarriers CH1 (421(1)), CH2 (421(2)), CH3 (421(3)), CH4 (421(4)), and also two OOB communication subcarriers (422) disposed between data subcarriers CH1 (421(1)) and CH2 (421(2)), and between data subcarriers CH3 (421(3)) and CH4 (421(4)). For this experimental validation, data subcarriers CH1 (421(1)) and CH3 (421(3)) utilized a 6.25 GBd DP-QPSK modulation, and data subcarriers CH2 (421(2)) and CH4 (421(4)) utilized a 6.25 GBd DP-16QAM modulation. Communication subcarriers (422) each operated at 312.5 MBd using DP-QPSK modulation.

For this experiment, one communication subcarrier (422) (between data subcarriers CH1 (421(1)) and CH2 (421(2)), in this example) was reserved for P2MP applications (i.e., MAC control signals and OAM information), and the other communication subcarrier (422) (between data subcarriers CH3 (421(3)) and CH4 (421(4)), in this example) was reserved for P2P scenarios. In this manner, the P2MP communication subcarrier (422) was utilized by a first upstream signal (424) using the frequency band for data subcarrier CH1 (421(1)) (i.e., 50 km, 64 split, medium-reach P2MP end-users 404), a second upstream signal (426) using the frequency band for data subcarrier CH2 421(2) (i.e., 25 km, 128 split, short-reach P2MP end-users 404), and a third upstream signal (428) using the frequency band for data subcarrier CH3 421(3) (i.e., 80 km, 32 split, long-reach P2MP end-users 404). In comparison, the P2P communication subcarrier (422) was utilized by a fourth upstream signal (430) using the frequency band for data subcarrier CH4 (421(4)) (i.e., 50 km, medium-reach P2P end-user (404)).

Thus, as demonstrated by the test architecture (400), an optical distribution network (ODN) may be advantageously configured to cater to a variety of distributed splitting and connectivity requirements, thereby offering significantly superior flexibility when compared with conventional techniques. In some instances, subcarriers modulated by QPSK may be more desirable to support medium to long-range services having substantial link budgets, whereas 16QAM subcarriers may be desirable for higher capacity services over shorter- to medium-range links. In the embodiment depicted in FIG. 4A, CH1 supported a 50 km reach with a 1×64 split, CH3 extended to 80 km with a 1×32 split for medium to long-range services, CH2 provided P2MP services over a 25 km link with a 1×128 split, and CH4 facilitated P2P services across a 50 km fiber link. In the upstream direction, CH1, CH2, and CH3 transmitted TFDM burst signals, whereas CH4 operated continuously to support P2P service.

In an embodiment, it may be desirable to position the OOB communication subcarriers (422) between respective TFDM data subcarriers based on the impact of the position OOB communication subcarrier on its neighboring TFDM data subcarriers. For example, in some cases, a communication subcarrier (422) may be able to affect power distribution and signal-to-noise ratio (SNR) of neighboring data subcarriers. In such instances, communication subcarriers (422) may be further configured to include a guard band between the particular communication subcarrier and its neighboring data subcarriers.

FIG. 5A is a graphical illustration depicting a plot (500) obtained using the test architecture (400) of FIG. 4. More particularly, the plot (500) illustrates the influence of the ratio between the communication subcarrier power, Pc, and the data subcarrier power, Pd, namely, the Pc/Pd power ratio on the data carrier bit-error-rate (BER) performance. As may be seen from the plot (500), the data subcarrier performance remains substantially unaffected when the Pc/Pd power ratio is below approximately −8.5 dB.

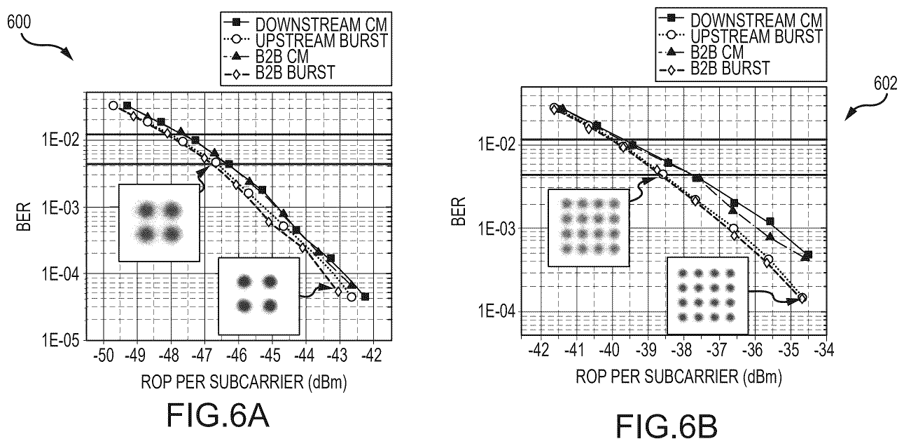

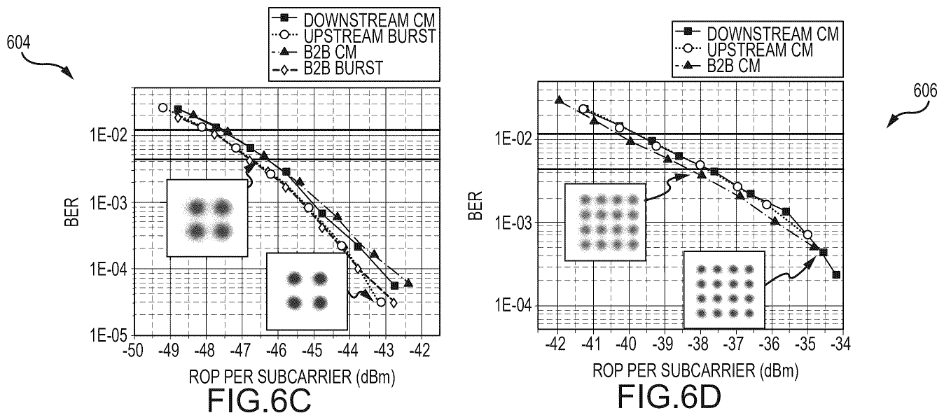

FIG. 5B is a graphical illustration depicting a plot (502) obtained using the test architecture (400) of FIG. 4. More particularly, the plot (502) illustrates the impact of guard band size (in GHz) on BER performance. To obtain the plot (502), the Pc/Pd power ratio was kept relatively constant at −10 dB. As may be seen from the plot (502), no data subcarrier performance penalty was observed for guard band sizes exceeding 0.4 GHz. For the additional experimental test results described below with respect to FIGS. 6A-6D, a guard band of 1.864 GHz was maintained for minimal data subcarrier impact.

FIGS. 6A-6D are graphical illustrations depicting performance plots (600), (602), (604), (606), respectively, obtained using the test architecture (400) of FIG. 4. That is, to assess the performance of the hybrid TFDM CPON of the test architecture (400) for both continuous (CW) downstream and burst upstream transmission, TFDM subcarriers CH1, CH2, CH3, CH4 were individually analyzed for BER relative to received optical power (ROP), along with their corresponding constellation diagrams. For each of performance plots (600), (602), (604), (606), upstream and downstream BER vs. ROP results are superimposed with comparative Back-to-Back (B2B) results, along with thresholds for hard-decision and soft-decision forward error correction (FEC).

Accordingly, the performance plot (600) of FIG. 6A, illustrates the BER performance of TFDM subcarrier CH1 measured for a continuous downstream, burst upstream, continuous B2B, and burst B2B. Similarly, the performance plot (602) of FIG. 6B, illustrates similar BER performance results for TFDM subcarrier CH2, and the performance plot (604) of FIG. 6C, illustrates similar BER performance results for TFDM subcarrier CH3. In contrast, the performance plot (606) of FIG. 6D, illustrates measured results for P2P services (i.e., upstream P2P signal (430), FIG. 4A), and therefore depicts superimposed performance results for continuous mode transmission in both the downstream and upstream directions, as well as B2B. The person of ordinary skill in the art may therefore observe, from performance plots (600), (602), (604), (606) that the present adaptive TFDM CPON systems and methods provide significant versatility and effectiveness for both continuous and burst signals, while also advantageously accommodating various user capacities, link budgets, distances, and other scenarios without sacrificing robust system performance.

Turning to FIGS. 7A, 7B, 8A, 8B, 9A, and 9B, a second experimental setup and results will now be described.

FIG. 7A is a schematic illustration of another example test architecture (700) for verifying experimental results implementing the adaptive TFDM CPON embodiments described herein. The example test architecture (700) employs both adaptable modulation formats and baud rates tailored to meet specific service requirements for an optical district network (ODN), which includes distributed splitting to support varying connectivity needs thereby enhancing overall system flexibility. More particularly, the test architecture (700) implemented a real-world operation of an adaptable TFDM CPON and included an OLT (702) operably coupled to various ONUs of respective end-users (704) through a number of dedicated optical fiber segments (706).

For this experiment, a first fiber segment (706(1)) connected the OLT (702) to a first splitter (708) over a 25 km length. From the first splitter (708), a second splitter (710) was configured to implement a 1×32 split ratio for a plurality of high-capacity (i.e., 187.5G), short-reach end-users (704). A second fiber segment (706(2)), also of 25 km, connected the first splitter (708) to a third splitter (712). From the third splitter (712), a fourth splitter (714) was configured to implement a 1×64 split ratio to service medium-capacity (i.e., 100G), medium-reach end-users (704). A third fiber segment (706(2)) of 30 km connected the third splitter (712) to a fifth splitter (713) configured to implement a 1×128 split ratio to service low-capacity (i.e., 25G), long-reach end-users (704). Additionally, a 10G OOB communication subcarrier is provided to enable communication functionalities such as, for example, MAC control signals and OAM information in the downstream direction.

At the OLT (702), four subcarriers (724(1-4)) were generated to support downstream services. The subcarriers (724) each have a unique baud rate and modulation format. More specifically, CH1 (724(1)) employs 6.25 GBd DP-QPSK, CH2 (724) (2) utilizes 12.5 GBd DP-16QAM, CH3 (724(3)) carries 15.625 GBd DP-64QAM, and CH4 (724) (4) adopts 2.5 GBd DP-QPSK signals. An initial internal oversampling rate of 62.5 GSa/s is used in determining the unique baud rates. Each baud rate is set as a fraction of the oversampling rate of 62.5 GSa/s for generating the payload data in each digital subcarrier and enabling Nyquist pulse shaping for optimal spectral efficiency.

The OLT (702) also includes a TFDM Burst Reception (726) for receiving digital subcarriers transmitted in TFDM burse mode in the upstream direction. Each digital subcarrier is capable of transmitting TDM burst signals to serve multiple end-users effectively.

Though not shown, a TFDM TX for the example test architecture (700) is the same as the TFDM TX (434) described above in FIG. 4B and a TFDM RX for the example test architecture (700) is the same as the TFDM RX (436) described above in FIG. 4C.

Turning to FIG. 7B, a downstream signal (720) was propagated in which subcarriers were positioned based on frequency offset on various signals. More specifically, digital subcarrier CH1 (724(1)) (6.25 GBd DP-QPSK) was placed at −18.75 GHz, digital subcarrier CH2 (724(2)) (12.5 GBd DP-16QAM) was placed at +21.875 GHz, CH3 (724(3)) (15.625 GBd DP-64QAM) at 0 GHz, and digital subcarrier CH4 (724(4)) (2.5 GBd DP-QPSK) was placed at −24 GHz, relative to the optical carrier frequency, to optimize system performance.

To optimize signal performance across multiple digital subcarriers, each subcarrier with a different modulation format and baud rate, Nyquist pulse shaping was applied to the signal. The Nyquist pulse shaping uses a root-raised-cosine filter to enable spectrally efficient transmission. The filter is defined by the symbol period T and a roll-off factor β(0≤β≤1). A smaller roll-off factor β is generally preferred for its ability to enhance spectral efficiency and resilience to CD and polarization mode dispersion (PMD). However, a smaller roll-off factor β also results in a narrower eye opening, increasing the signal's susceptibility to transmitter skew, which is especially critical for higher-order QAM formats.

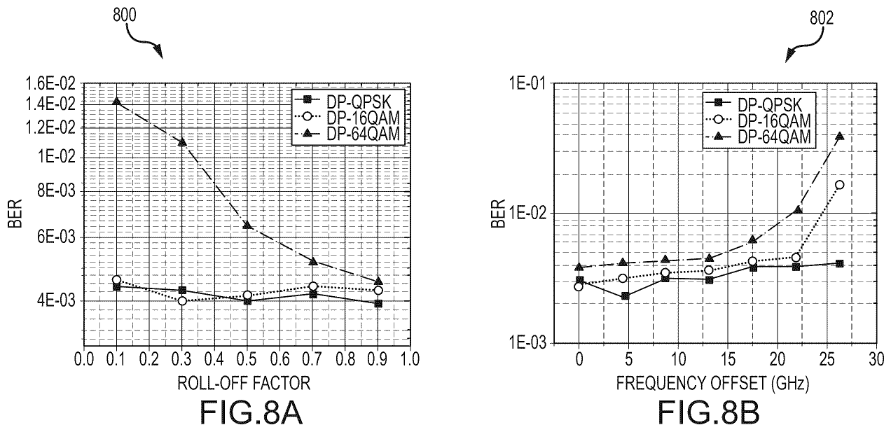

FIG. 8A illustrates a plot (800) showing a BER dependence on the roll-off factor β for three modulation formats (6.25 GBd DP-QPSK, 12.5 GBd DP-16QAM, and 15.625 GBd DP-64QAM) at a fixed received optical power (ROP). For DP-QPSK, the ROP is-46 dBm, while for DP-16QAM and DP-64QAM, the ROP is −36 dBm and −28 dBm, respectively. The results reveal that the BER for DP-QPSK and DP-16QAM remains relatively stable across different values of the roll-off factor β, while the DP-64QAM signal shows a significant sensitivity due to its increased vulnerability to a narrower eye opening and skew effects. Based on such observations, a roll-off factor of β=0.1 for DP-QPSK and DP-16QAM signals, and β=0.9 for DP-64QAM signals are selected, ensuring an optimal balance between signal performance and spectral efficiency.

Turning to FIG. 8B, a plot (802) of the BER performance for three modulation formats as a function of frequency offset is provided. The plot (802) can be used to analyze the influence of frequency offset on various signals. The frequency offset refers to a deviation between center frequency of a digital subcarrier and a frequency of the optical carrier. As shown, the 15.625 GBd DP-64QAM signal, with a 0.9 roll-off factor β and a broader spectral width, shows greater sensitivity to frequency offset, particularly when shifted further from the optical carrier frequency. In contrast, the DP-QPSK and DP-16QAM signals demonstrate a more robust tolerance to frequency offset.

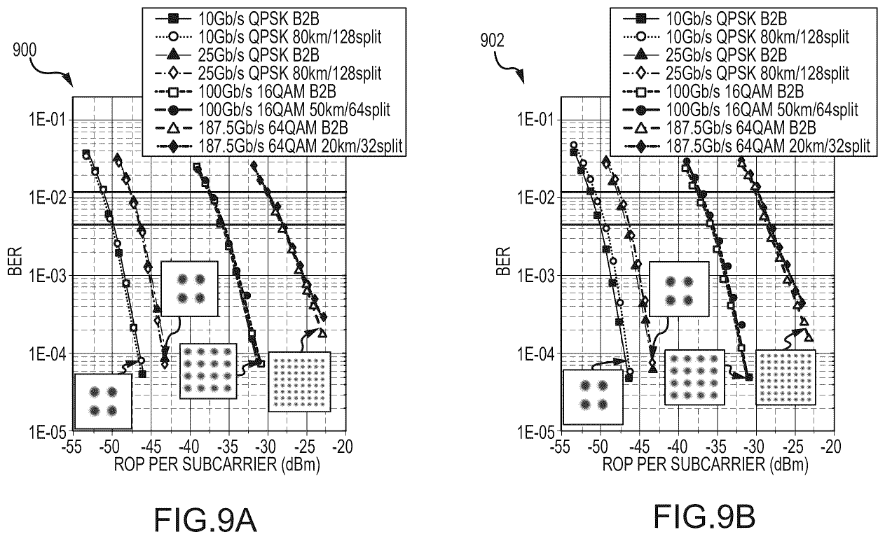

FIG. 9A illustrates a plot (900) of the BER performance as a function of ROP per digital subcarrier for the downstream transmission. In the plot (900) shown, each digital subcarrier is configured with a distinct baud rate and modulation format: digital subcarrier CH1 with 6.25 GBd DP-QPSK, digital subcarrier CH2 with 12.5 GBd DP-16QAM, digital subcarrier CH3 with 15.625 GBd DP-64QAM, and digital subcarrier CH4 with 2.5 GBd DP-QPSK. Similarly, FIG. 9B shows a plot (902) of the BER performance versus ROP results for the TFDM upstream transmission, where each digital subcarrier transmits signals in TDM bursts. Both figures include B2B BER results and thresholds for staircase hard-decision (HD) forward error correcting (FEC) and concatenated soft decision (SD) FEC.

The receiver sensitivity at the concatenated SD FEC threshold of 1.2×10⁻² remained consistent for both downstream and upstream transmission. Specifically, the receiver sensitivity values were approximately −47.8 dBm for digital subcarrier CH1, −37.5 dBm for digital subcarrier CH2, −30 dBm for digital subcarrier CH3, and −51 dBm for digital subcarrier CH4. By utilizing simpler modulation formats like QPSK for extended reach and higher-order QAM such as 64QAM for shorter distances, the results indicate negligible impact on receiver sensitivity due to fiber transmission. These results confirm the effectiveness of the proposed rate-flexible TFDM CPON architecture.

As described herein, innovative adaptable TFDM CPON techniques and architectures are provided that advantageously enable adaptable modulation formats, baud rates, and adjustable link budgets across multiple subcarriers and additional communication channels for diverse applications and end-user needs/requirements. Experimental validation results further demonstrate the flexibility of the present adaptable TFDM CPON to accommodate distributed splitting over various distances (i.e., 25 km/128 split, 50 km/64 split, 80 km/32 split, 25 km/32 split, 80 km/128 split) for respective P2MP topologies, and with direct connections for P2P topologies (i.e., 50 km/P2P link). The experimental validation further demonstrated the adaptable TFDM CPON's ability to adapt in modulation format as well as baud rates, thus enhancing the adaptable TFDM CPON's versatility in supporting various service requirements.

The present embodiments of the adaptable TFDM CPON further feature utilization of OOB communication subcarriers to support control signals and OAM information advantageously disposed between respective data channel subcarriers. Systems and methods utilizing the present adaptable TFDM CPON architecture also advantageously accommodate both downstream continuous transmissions and upstream burst transmissions. This capability enables efficient support for P2MP and P2P scenarios, and the simultaneous use of TDM within digital subcarriers to serve multiple end-users.

The advantageous techniques of the adaptive TFDM CPON system (100) enable significant flexibility for digital subcarrier management (i.e., by the OLT 102 of FIG. 1) in consideration of various end-user parameters or requirements, considered individually or together, including without limitation capacity, latency, topology (i.e., P2P and/or P2MP), and distance from the OLT. Further, the adaptive TFDM CPON system (100) described above beneficially uses less components than a conventional CPON system.

Exemplary embodiments for hybrid TFDM CPONs are described above in detail. The systems and methods of this disclosure though, are not limited to only the specific embodiments described herein, but rather, the components and/or steps of their implementation may be utilized independently and separately from other components and/or steps described herein. Additionally, the exemplary embodiments can be implemented and utilized in connection with other access networks utilizing fiber and coaxial transmission at the end user stage.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, i.e., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A coherent passive optical network (CPON), comprising:
an optical line terminal (OLT) configured to transmit a downstream optical signal to a plurality of optical network units (ONUs) disposed remotely from the OLT, the downstream optical signal including a first data subcarrier, a second data subcarrier, and a communication subcarrier each disposed in a frequency domain;
an optical communication medium in operable communication with the OLT, and configured to transport the downstream optical signal to a first ONU and a second ONU;
the first ONU of the plurality of ONUs in operable communication with the optical communication medium, including a first ONU receiver configured to receive at least the first data subcarrier having a first modulation format and a first baud rate from the downstream optical signal within a first channel bandwidth, and a first ONU transmitter configured to transmit at least a first upstream data subcarrier to the OLT within the first channel bandwidth; and
the second ONU of the plurality of ONUs in operable communication with the optical communication medium, including a second ONU receiver configured to receive at least the second data subcarrier having a second modulation format and a second baud rate from the downstream optical signal within a second channel bandwidth, and a second ONU transmitter configured to transmit at least a second upstream data subcarrier to the OLT within the second channel bandwidth; and
wherein the communication subcarrier includes at least one of OAM management data and information for control of a media access control (MAC) layer.

2. The CPON of claim 1, wherein the first modulation format is different from the second modulation format and the first baud rate is different from the second baud rate.

3. The CPON of claim 1, further comprising:
the third ONU of the plurality of ONUs in operable communication with the optical communication medium, including a third ONU receiver configured to receive at least the third data subcarrier having a third modulation format and a third baud rate from the downstream optical signal within a third channel bandwidth, and a third ONU transmitter configured to transmit a third upstream signal to the OLT within the third channel bandwidth; and
the fourth ONU of the plurality of ONUs in operable communication with the optical communication medium, including a fourth ONU receiver configured to receive at least the fourth data subcarrier having a fourth modulation format and a fourth baud rate from the downstream optical signal within a fourth channel bandwidth, and a fourth ONU transmitter configured to transmit a fourth upstream signal to the OLT within the fourth channel bandwidth.

4. The CPON of claim 3, wherein the communication subcarrier is a first communication subcarrier, and wherein the downstream optical signal further includes a second communication subcarrier.

5. The CPON of claim 4, wherein the second communication subcarrier is dedicated for P2P operation.

6. The CPON of claim 5, wherein the first, second, and third ONUs utilize the first communication subcarrier and are each configured for a point-to-multipoint (P2MP) split ratio, and wherein the fourth ONU utilizes the second communication subcarrier and is configured for P2P transport.

7. The CPON of claim 3, wherein the first modulation format, the second modulation format, the third modulation format, and the fourth modulation format are each different, and wherein the first baud rate, the second baud rate, the third baud rate, and the fourth baud rate are each different.

8. The CPON of claim 3, wherein the first baud rate, the second baud rate, the third baud rate, and the fourth baud rate are set as a fraction of an initial internal oversampling rate.

9. The CPON of claim 7, wherein the initial internal oversampling rate is 62.5 GSa/s.

10. The CPON of claim 1, wherein the first data subcarrier and the second data subcarrier are each high speed data and the communication subcarrier is low speed data.

11. A digital signal processor (DSP) for a coherent transmitter, comprising:
a channel configuration unit configured to divide a media access control (MAC) data signal into a plurality of digital subcarriers, each digital subcarrier assigned to a frequency band;
a plurality of payload generators configured to generate a payload and to assign a baud rate to each digital subcarrier of the plurality of digital subcarriers;
a plurality of channel encoders configured to receive, encode, and assign a modulation format to data for each digital subcarrier of the plurality of digital subcarriers;
a post-processing unit including at least one of a pulse shaper and a digital up-converter for the plurality of digital subcarriers; and
a channel combination unit configured to combine the data into a combined output signal capable of conversion to an analog optical signal for output from the coherent transmitter.

12. The DSP of claim 11, wherein the transmitter is an ONU coherent transmitter, and wherein the ONU coherent transmitter further comprises a burst preamble generator logically disposed between the plurality of payload generation and the plurality of channel encoders, the burst preamble generator configured to construct a preamble for the payload of a respective subcarrier, the preamble including one or more of a guard band, a receiver settling pattern, and a synchronization pattern.

13. The DSP of claim 11, wherein the assigned baud rate is different for at least two subcarriers.

14. The DSP of claim 11, wherein the assigned modulation format is different for at least two subcarriers.

15. The DSP of claim 1, wherein the assigned frequency band is different for at least two subcarriers.

16. The DSP of claim 11, wherein the pulse shaper applies a Nyquist pulse shaping to each subcarrier.

17. A digital signal processor (DSP) for a coherent receiver, comprising:
a digital down converter configured to receive digital subcarriers from the coherent receiver and separate the digital subcarriers into respective baseband signals;
a plurality of channel filters configured to filter each respective baseband signal and process a baud rate for each baseband signal;
a joint DSP processor for processing the digital subcarriers;
a plurality of channel decoders configured to individually receive and decode each digital subcarrier that is output from the joint DSP processor.

18. The DSP of claim 17, wherein the coherent receiver comprises an OLT coherent receiver, and wherein the OLT coherent receiver further comprises a burst detection and synchronization unit logically disposed between the plurality of channel filters and the joint DSP processor, the burst detection and synchronization unit configured to detect burst signal according to a preamble thereof, and then implement one or more of burst frame detection, chromatic dispersion (CD) compensation, burst clock recovery, and burst frame synchronization.

19. The DSP of claim 17, wherein the baud rate is different for at least two digital subcarriers.

20. The DSP of claim 17, wherein the assigned modulation format is different for at least two digital subcarriers.
